(19) United States
(12) Patent Application Publication
(10) Pub. No.: US 2005/0182937 A1
(43) Pub. Date: Aug. 18, 2005

(54) Method and system for sending secure messages over an unsecured network

(76) Inventor: Harmeet Singh Bedi, Waterloo (CA)

Correspondence Address: HARMEET S. BEDI, 574 NEW BEDFORD DRIVE, WATERLOO, ON, N2K 4H5, CA

(21) Appl. No.: 11/052,105

(22) Filed: Feb. 8, 2005

Related U.S. Application Data
(60) Provisional application No. 60/543,566, filed on Feb. 12, 2004.

(51) Int. Cl. H04L 9/00

(52) U.S. Cl. 713/171

(57) ABSTRACT

The present invention is directed to a system and method for providing the secure exchange of messages utilizing an existing unsecured messaging network such as the Internet. A messaging proxy is provided between a sender of a message and the unsecured messaging network. In sending a secure message, the messaging proxy contacts a key exchange server via an authenticated secure connection. The messaging proxy generates a key with which to encrypt the message. The key is sent via an authenticated secure connection to a messaging proxy of a recipient. If the sender receives an acknowledgement of the recipient receiving the key, the message is encrypted and sent via the unsecured messaging network. The recipient then uses the key to decrypt the message. Should the recipient not have a proxy in place to receive encrypted messages and a corresponding key exchange server, the message is sent unencrypted.

### RELATED APPLICATION

This application claims priority from provisional application 60/543,566 filed Feb. 12, 2004, the disclosure of which is incorporated herein by reference.

### BACKGROUND OF THE INVENTION

The invention relates in general to secure electronic communication and in particular to creating a transparent secure network for use with peer to peer messaging applications.

When an electronic message is sent via the Internet, the message generally travels through a number of gateways, routers, and other intermediaries between the sender and the recipient. While the message is in transit, third parties may have access to the message, so that privacy of the communication cannot be presumed. For that reason, parties using the Internet to transmit sensitive data (e.g., credit card information or business transaction information) usually desire to send encrypted messages that can be decrypted only by the intended recipient.

Communication of encrypted messages generally requires establishing a “shared secret” known to both the sender and recipient but not known to any third party. The shared secret typically acts as a key that can be used to encrypt and decrypt messages. This shared secret must be available to the recipients to be able to decrypt an encrypted message.

Public key infrastructure (PKI) through certificate distribution between peers can be used to secure network communication. Secure Socket Layer (SSL) uses PKI to provide privacy and authentication between two network endpoints for synchronous communication. PKI, however does not work well for ad hoc secure network creation when the sender and recipient are not directly connected. PKI requires the distribution of public/private key pairs to each participant in the secure network. To encrypt a message utilizing PKI requires encryption using the public key followed by symmetric key encryption.

Certificate distribution, the need for application retooling, authentication and high computation expense makes PKI ineffective for transparently adding privacy to existing messaging applications.

One cannot encrypt a message using a shared secret and send the shared secret along with encrypted message. If this were done, someone in the network path could use the shared key to read the message. Detecting and sending secure messages conventionally requires adding security and messaging protocol changes to existing applications or creating a private secure network between a message sender and recipient. This is often neither feasible nor cost effective.

Thus, there is a need for an efficient and scalable method and system for transparently adding privacy to existing messaging applications. In particular a system that discovers if secure messaging is possible between two or more parties and adding security without requiring any application changes. The present invention addresses this need.

### BRIEF DESCRIPTION OF THE DRAWINGS

FIG. 1 is a block diagram of the components of a communication system utilizing the present invention;

FIG. 2 is a sequence diagram of a prior art process for sending unencrypted messages;

FIG. 3 is a sequence diagram of a process for sending messages when only the sending side has a messaging proxy; and

FIGS. 4a and 4b illustrate a sequence diagram of a process for sending and receiving encrypted messages when the sending side and receiving side have message proxies.

### DETAILED DESCRIPTION OF THE INVENTION

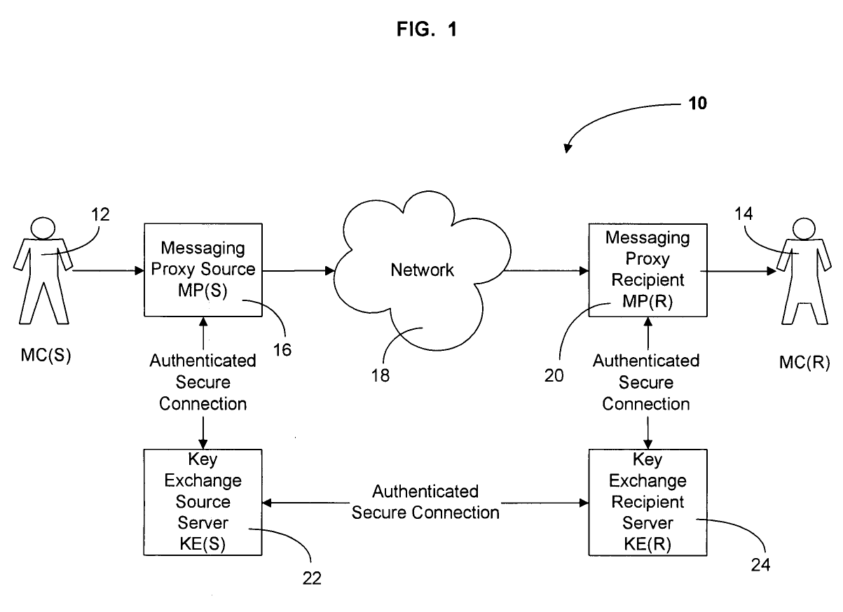

To aid the reader in understanding the present invention we refer first to FIG. 1, a block diagram of the components of a communication system utilizing the present invention. The communication system is shown generally as 10. In use, a Messaging Client Sender (MC(S)) 12 sends a message to a Messaging Client Recipient (MC(R)) 14. A message may take any form. For example: email, Internet Instant Messaging services (e.g. IRC. ICQ), Push to Talk (PTT), Peer to Peer (P2P) or Voice over Internet Protocol (VoIP). The present invention is not restricted in use to a specific type of a message sent by a sender MC(S) 12 to a recipient MC(R) 14.

Any message sent by a sender MC(S) 12 is intercepted and encrypted by Messaging Proxy Source (MP(S)) 16 before it is sent to receiver MC(R) 14. MP(S) 16 resides between a sender MC(S) 12 and a network 18, which delivers a message to recipient MC(R) 14. Network 18 may utilize any protocol for carrying messages sent by MC(S) 12, for example TCP/IP over the Internet.

On the recipient MC(R) 14 side of the connection there resides a Messaging Proxy Recipient (MP(R)) 20 which receives an encrypted message from sender MC(S) 12 via network 18 and decrypts the message before forwarding it to receiver MC(R) 14.

MP(S) 16 generates a key for encrypting and decrypting the message and sends it to KE(S) 22. In turn KE(S) 22 utilizing an authenticated secure connection forwards the key to a Key Exchange Recipient Server (KE(R)) 24. The key is based upon fast symmetric encryption such as Data Encryption Standard (DES), Triple-DES or Advanced Encryption Standard (AES). It is not the intent of the inventor to restrict the use of the present invention to a specific type of encryption, any encryption method that provides a symmetric key, i.e. a key used for both encrypting and decrypting may be utilized. In essence KE(S) 22 and KE(R) 24 act as a switch to pass keys over an authenticated secure network between MP(S) 16 and MP(R) 20.

All key exchange servers (22, 24), have a unique domain name and each messaging proxy (16, 20) is aware of the key exchange server domain name. Through the use of the Domain Name System (DNS) a domain name is resolved by a messaging proxy to all the Internet Protocol (IP) addresses of key exchange servers. A messaging proxy connects to only one key exchange server. In selecting a key exchange server a messaging proxy attempts to distribute messaging proxy connection load across key exchange servers. This may be done by randomly picking any of the key exchange servers to connect to. Should there be a connection failure between a messaging proxy and a key exchange server, the messaging proxy will select another key exchange server. Each messaging proxy server and key exchange server maintains an existing connection as long as possible. Connection initialization is computationally expensive, but exchanging data over an existing connection between a key exchange server and messaging proxy server has low overhead.

The sender and recipient sides are symmetric. In other words MP(S) 16 in combination with KE(S) 22 provide the same functionality as MP(R) 20 combined with KE(R) 24. Either side could be a sender or recipient.

The message and the key are sent via different communication paths. In particular, the key is sent via an authenticated secure connection from MP(S) 16 to MP(R) 20 through KE(S) 22 and KE(R) 24. Upon receiving a message that is encrypted via network 18, MP(R) 20 utilizes the key to decrypt the message. Once decrypted the message is forwarded to recipient MC(R) 14.

Should a recipient MC(R) 14 not have a proxy MP(R) 20 in place, then messages will be sent unencrypted. Thus the present invention may send messages encrypted or unencrypted dependent upon whether a recipient MC(R) 14 has a proxy MP(R) 20 in place. In the present embodiment, should a message be sent to multiple recipients MC(R) 14, an encrypted version of the message will be sent only if each recipient has an MP(R) 20 to decrypt the message. Other embodiments for a specific type of messaging service may choose to send a message to multiple recipients encrypted if the recipient has a MP(R) 20 in place and unencrypted if not.

Establishing an authenticated secure connection is done via a protocol such as Secure Socket Layer (SSL). By way of example, an SSL protocol connection between a messaging proxy server (16, 20) and a key exchange Server (22, 24) or between key exchange servers (22, 24) may be authenticated by ensuring each end of the connection has digital identities issued by a certificate authority. These identities are exchanged and verified when connection is initiated by each end using public key encryption and certificate authority verification, such as used in Internet based eCommerce transactions. One embodiment of the present invention utilizes a mutually authenticated secure connection, however other embodiments may not require mutual authentication. Authentication by one side of the connection may be deemed sufficient in other embodiments.

Although MPS(16), KE(S) 22, MP(R) 20 and KE(R) 24 have been shown as distinct blocks within FIG. 1, it is not the intent of the inventor that they need to reside on individual physical computing devices. They are in essence four distinct logical components and may reside on one or more physical computing devices.

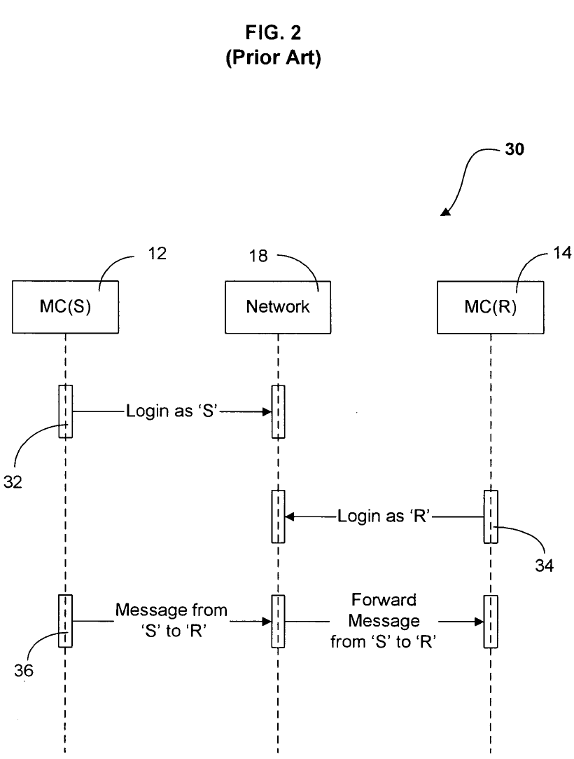

Referring now to FIG. 2 a sequence diagram of a prior art process for sending unencrypted messages is shown generally as 30. Beginning at step 32 a sender MC(S) 12 logs into a service on network 18 for sending and receiving messages. Such a service may include: email, Internet Instant Messaging services (e.g. IRC. ICQ), Push to Talk (PTT), Peer to Peer (P2P) or Voice over Internet Protocol (VoIP). This disclosure makes use of the term ‘login’ to simply announce that a sender or recipient is available for sending or receiving messages using a certain service. An explicit login may not be required, for example a user may not be required to login to an email server.

Similarly a recipient MC(R)14 logs into the same service at step 34. At step 36 sender MC(S) 12 sends a message to recipient MC(R) 14 via network 18. The sent message is not encrypted and is passed directly via network 18 to recipient MC(R) 14.

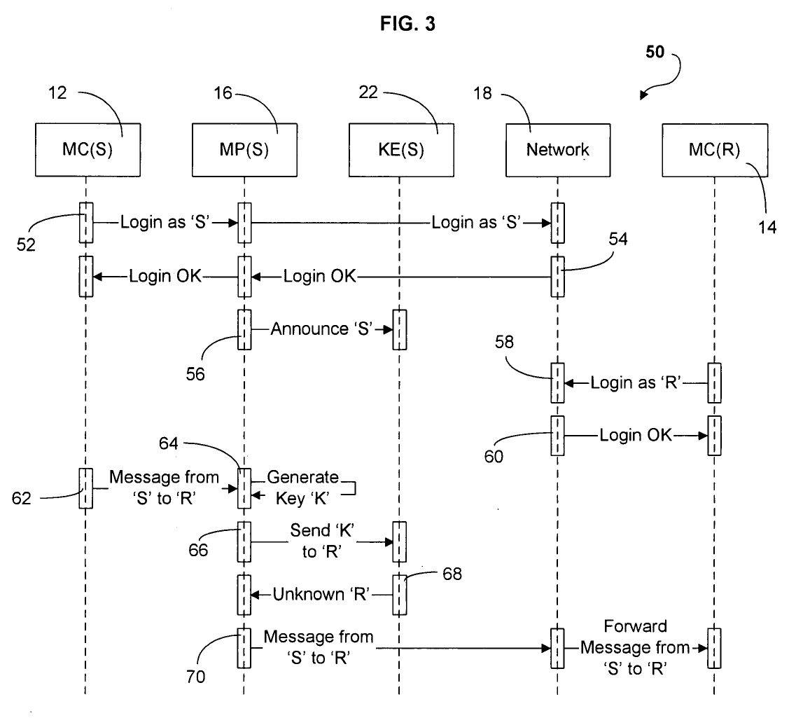

Referring now to FIG. 3 a sequence diagram of a process for sending messages when only the sending side has a messaging proxy is shown generally as 50. Beginning at step 52 a sender MC(S) 12 logs into a proxy MP(S) 16 which passes the login information to a service on network 18 for sending and receiving messages. Such a service may include: email, Internet Instant Messaging services (e.g. IRC, ICQ), Push to Talk (PTT), Peer to Peer (P2P) or Voice over Internet Protocol (VoIP). At step 54 the service on network 18 acknowledges the login request and passes the acknowledgement to proxy MP(S) 16. Proxy MP(S) 16 then passes the acknowledgement on to sender MC(S) 16.

In an alternative embodiment login step 52 and acknowledgement step 54 may not be required. For example should MC(S) 12 be sending messages via a dedicated email server, then login may not be required. In this alternative embodiment MP(S) 16 sends to KE(S) 22 a list of recipients that may receive secure messages. KE(S) 22 is aware of the identity of MP(S) 16 at the time they connect with each other and may validate the list of recipients. For example, a list of recipients could refer to all addresses for a specific domain.

Moving to step 56, proxy MP(S) 16 announces to server KE(S) 22 that it is capable of handling the encryption of messages for the service the sender MC(S) 12 has logged into. KE(S) 22 will retain the information on the userid of the sender, the type of service logged into, and the address of the authenticated secure connection. If the authenticated secure connection is terminated, this information is purged.

Similarly a recipient MC(R) 14 logs into the same service at step 58. At step 60 network 18 acknowledges the login and informs recipient MC(R) 14. In an alternative embodiment login step 58 and acknowledgement step 60 may not be required. For example should MC(S) 12 be sending messages via a dedicated email server, then login may not be required.

At step 62 a message is sent by sender MC(S) 12 to recipient MC(R) 14 via proxy MP(S) 16. At step 64 proxy MP(S) 16 generates a key ‘K’ to encode/decode the message. At step 66 an attempt is made by MP(S) 16 to send the key to MC(R) 14. KE(S) 22 maintains a list of all recipients capable of receiving an encrypted message. In this example, since MC(R) 14 does not have a proxy to handle encrypted messages in place, KE(S) 22 informs MP(S) 16 of this at step 68. At step 70 an unencrypted version of the message is sent by proxy MP(S) 16 via network 18 to recipient MC(R) 14.

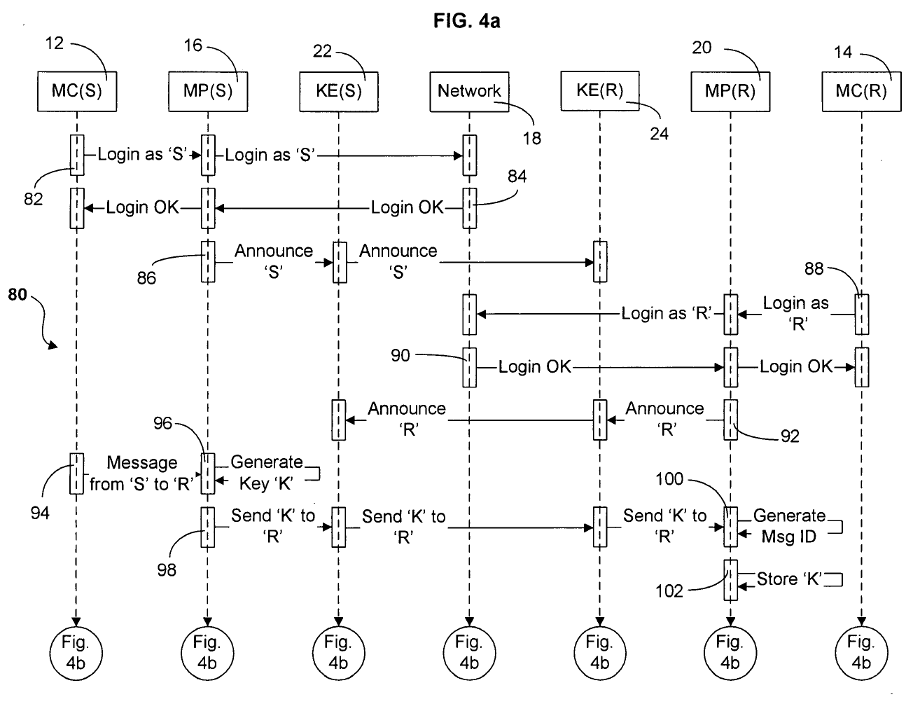

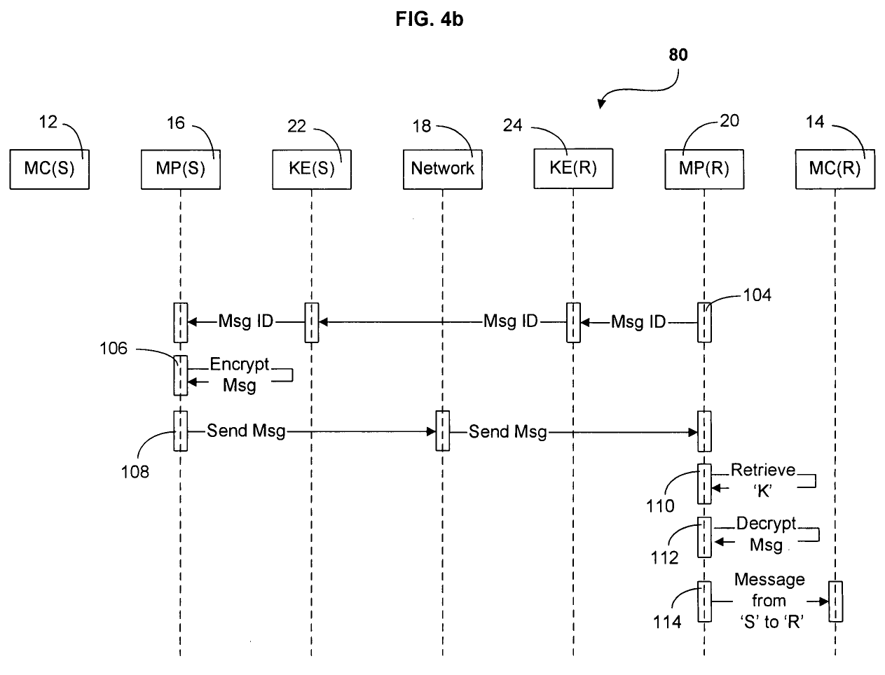

Referring now to FIGS. 4a and 4b, a sequence diagram of a process for sending and receiving encrypted messages when the sending side and receiving side have message proxies is indicated generally by 80. Beginning at step 82 of FIG. 4a, a sender MC(S) 12 logs into a proxy MP(S) 16 which passes the login information to a service on network 18 for sending and receiving messages. Such a service may include: email, Internet Instant Messaging services (e.g. IRC, ICQ), Push to Talk (PTT), Peer to Peer (P2P) or Voice over Internet Protocol (VoIP).

At step 84 the service on network 18 acknowledges the login request and passes the acknowledgement to proxy MP(S) 16. Proxy MP(S) 16 then passes the acknowledgement on to sender MC(S) 12.

In an alternative embodiment login step 82 and acknowledgement step 84 may not be required. For example should MC(S) 12 be sending messages via a dedicated email server, then login may not be required. In this alternative embodiment MP(S) 16 sends to KE(S) 22 a list of recipients that may receive secure messages. KE(S) 22 is aware of the identity of MP(S) 16 at the time they connect with each other and may validate the list of recipients. For example, a list of recipients may refer to all addresses for a specific domain.

Moving to step 86, proxy MP(S) 16 announces to server KE(S) 22 that it is capable of handling the encryption of messages for the service that sender MC(S) 12 has logged into. Server KE(S) 22 announces this to all servers KE (R) 24.

At step 88 a recipient MC(R) 14 logs into the same service as the sender MC(S) 12. At step 90 network 18 acknowledges the login and informs recipient MC(R) 14. In an alternative embodiment login step 88 and acknowledgement step 90 may not be required. For example should MC(R) 14 be receiving messages via a dedicated email server, then login may not be required. In this alternative embodiment MP(R) 20 sends to KE(R) 24 a list of recipients from which it may receive secure messages. For example should MP(R) 20 be receiving messages via a dedicated email server, then login may not be required. In this alternative embodiment MP(R) 20 sends to KE(S) 22 a list of recipients that may receive secure messages. KE(R) 24 is aware of the identity of MP(R) 24 at the time of connection and may validate the list of recipients. For example, a list of recipients could refer to all addresses for a specific domain.

Moving to step 92, proxy MP(R) 20 announces to server KE(R) 24 that it is capable of handling encrypted messages sent to recipient MC(R) 14 for the service MC(R) 14 has logged into. Server KE(R) 24 announces this to all servers KE (S). KE(R) 24 will retain the information on the userid of the recipient, the type of service logged into, and the address of the authenticated secure connection. If the authenticated secure connection is terminated, this information is purged.

At step 94 a message is sent by sender MC(S) 12 to recipient MC(R) 14 via proxy MP(S) 16. At step 96 proxy MP(S) 16 generates a key ‘K’ to encode/decode the message.

At step 98 MP(S) 16 sends to KE(S) 22 the following data:
a) key
b) an identifier to the type of messaging service
c) identifier for MC(S) 12, such as a userid
d) identifier for MC(R) 14, such as a userid
e) identifier for MP(S ) 16, such as a digital identity serial number
   which KE(S) forwards to KE(R) 24 via an authenticated secure connection. At step 100 MP(R) 20 receives the key and generates a unique message id associated with the key and at step 102 stores the key and unique message id.

Referring now to FIG. 4b, at step 104 MP(R) 20 responds to receiving the key by sending a message back to MP(S) 16 via the secure network connection to KE(S) 22 containing the following data:
a) key
b) unique message id
c) an identifier to the type of messaging service
d) identifier for MC(S) 12, such as a userid
e) identifier for MC(R) 14, such as a userid
f) identifier for MP(R) 20, such as a digital identity serial number This data is stored by MP(S) 16 until the message is received.

At step 106 having received the above information from MP(R) 20, MP(S) 16 encrypts the message using the key generated at step 96. MP(S) 16 also adds the unique message id to the message, which in one embodiment may be prefixed to the message. At step 108 the encrypted message is then sent to the recipient MC(R) 14 via network 18 and is intercepted by proxy MP(R) 20. At step 110, proxy MP(R) extracts the unique message id from the message and with that information, retrieves the key ‘K’ from its datastore. At step 112 the message is decrypted using the key and at step 114 the message is forwarded to recipient MC(R) 14.

To clarify the present invention, a message will only be encrypted if both the sender and recipient have messaging proxies (MP(S) 16 and MPS(R) 20) in place. If either proxy is not in place, a message will be sent unencrypted. This structure allows encrypted communication between some users while not requiring it for those who do not have messaging proxies in place. Thus, it is a transparent addition to existing methods and systems of exchanging messages. Further a system may be configured so that all message routing within a network is sent to a computer that works with a messaging proxy. In this situation a messaging proxy is not required for every computer in a network. For example, a network of computers may utilize a single email server. All email is routed through the email server and the email server would utilize a messaging proxy.

The network of key exchange servers comprises a variable number of servers. Each key exchange server has a unique domain name, which can be resolved to an IP address through the use of the DNS lookup feature. All key exchange servers are connected by a mutually authenticated SSL connection to ensure unauthorized servers do not join the network of key exchange servers. When an SSL connection is initiated, each connection end sends to the other a digital certificate to confirm their identity, thus establishing a mutual authenticated secure connection. Alternative embodiments may require authentication only on one side of the connection. A new key exchange server is added simply by providing the Internet Protocol address of the new key exchange server to the existing domain name for key exchange servers. A single domain name is utilized for all key exchange servers and all key exchange servers connect to each other. A new key exchange server connection is accepted only if the key exchange server IP address is one of the IP addresses in the domain name. This allows the network of key exchange servers to scale dynamically. Each messaging proxy is connected to only one key exchange server at a time. This limits the number of individual machines a key exchange server has to communicate with. Thus at most, there are only two hops from a messaging proxy to a first key exchange server and then a second key exchange server. This strategy provides for a predictable overhead in traffic between key exchange servers. Should any authenticated secure connection fail, be it between key exchange servers or a messaging proxy and a key exchange server, an attempt is made to establish a new connection and maintain it as long as possible.

Although the present invention has been described in parts as being a software based invention, it is the intent of the inventor to include computer readable forms of the invention. Computer readable forms meaning any stored format that may be read by a computing device.

Although the invention has been described with reference to certain specific embodiments, various modifications thereof will be apparent to those skilled in the art without departing from the spirit and scope of the invention as outlined in the claims appended hereto.

1. A system for sending secure messages through an unsecured network, said system comprising:
a) a messaging proxy source server, said messaging proxy source server operatively connected to said unsecured network; and
b) a key exchange source server, said key exchange source server operatively connected to said messaging proxy source server by a first authenticated secure connection, said first authenticated secure connection distinct from said unsecured network.

2. The system of claim 1 further comprising
c) a messaging proxy recipient server operatively connected to said unsecured network; and
d) a key exchange recipient server operatively connected to a key exchange source server by a second authenticated secure connection, and also operatively connected to said messaging proxy recipient server by a third authenticated secure connection, each of said second and third authenticated secure connections distinct from said unsecured network.

3. The system of claim 2 wherein all key exchange source servers and all key exchange recipient servers, announce to each other their availability to exchange data via said second authenticated secure connection.

4. The system of claim 2 further comprising logic for selecting an alternative key exchange recipient server or a key exchange source server should the first or third authenticated secure connections fail.

5. The system of claim 2 further comprising logic for a messaging proxy source server and messaging proxy recipient server to become aware of a new key exchange server.

6. The system of claim 2 further comprising logic for transparently adding a messaging proxy source server or a messaging proxy recipient server to utilize said unsecured network and said first, second and third authenticated secure connections.

7. A method for sending a message through an unsecured network, said method comprising the steps of:
a) utilizing a messaging proxy source server to obtain a key with which to encrypt said message;
b) utilizing a key exchange source server to provide said key to a key exchange recipient server via an authenticated secure connection;
c) encrypting said message using said key to create an encrypted message;
d) sending said encrypted message to a messaging proxy recipient server via said unsecured network;
e) utilizing said key to decrypt said encrypted message; and
f) delivering said message to a recipient.

8. The method of claim 7 wherein if said messaging proxy recipient server does not exist, sending said message without encryption.

9. The method of claim 7 further comprising the step of all key exchange source servers and key exchange recipient servers, announcing to each other their availability to exchange data via said authenticated secure connection.

10. The method of claim 7 further comprising the step of if a connection between a messaging proxy and a key exchange server fails, selecting an alternative key exchange server.

11. The method of claim 7 further comprising the step of transparently adding a messaging proxy source server or a messaging proxy recipient server to utilize said unsecured network and said authenticated secure connection.

12. A computer readable medium, said medium comprising instructions for sending a message through an unsecured network, said medium comprising instructions for:
a) utilizing a messaging proxy source server to obtain a key with which to encrypt said message;
b) utilizing a key exchange source server to provide said key to a key exchange recipient server via an authenticated secure connection;
c) encrypting said message using said key to create an encrypted message;
d) sending said encrypted message to a messaging proxy recipient server via said unsecured network;
e) utilizing said key to decrypt said encrypted message; and
f) delivering said message to a recipient.

13. The medium of claim 12 further comprising instructions for sending said message without encryption if said messaging proxy recipient server does not exist.

14. The medium of claim 12 further comprising instructions for all key exchange source servers and key exchange recipient servers to announce to each other their availability to exchange data via said authenticated secure connection.

15. The medium of claim 12 further comprising instructions that if a connection between a messaging proxy and a key exchange server fails selecting an alternative key exchange server.

16. The method of claim 12 further comprising instructions for transparently adding a messaging proxy source server or a messaging proxy recipient server to utilize said unsecured network and said authenticated secure connection.
